(19) United States
(12) Patent Application Publication
(10) Pub. No.: US 2011/0056727 A1
(43) Pub. Date: Mar. 10, 2011

(54) Core cable

(76) Inventor: Daniel Dwain Sanders, Southworth, WA (US)

(21) Appl. No.: 12/584,389

(22) Filed: Sep. 8, 2009

(51) Int. Cl. H01B 3/30

(52) U.S. Cl. 174/110 R

(57) ABSTRACT

A transmission cable comprises a conductive strand surrounded by an insulating casing. The conductive strand includes an inner core of a ferromagnetic material, a highly conductive metal skin disposed about the inner core, and a tinning disposed there between the highly conductive metal and the inner core.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to a low resistance conducting cable that would reduce energy losses inherent in many power grids.

### BACKGROUND OF THE INVENTION

Though estimates vary, power grids lose a substantial percentage of the electrical energy they carry. Energy conservation is of great importance as it reduces the amount of fossil fuels used and lessens dependence on imported oil. While progress has been made in creating more efficient transformers, there has been less progress made in designing truly efficient conductors. Aluminum conductors may waste energy in the transmission of AC power largely because of resistance which creates Joule heat and electromagnetic field emission losses. They also require the use of transformers over distances to “boost” the voltage creating further energy losses. There is a need for a conductor that more efficiently transfers electrical energy over long distances.

The instant invention as disclosed within this application, provides a conducting cable that fills this need. The art referred to and/or described within this application is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R.1.72. The abstract is not intended to be used for interpreting the scope of the claims.

### BRIEF SUMMARY OF THE INVENTION

In at least one embodiment, a transmission cable comprises at least one conductive strand surrounded by an insulating casing. The conductive strand(s) may include an inner core of a ferromagnetic material, a highly conductive metal skin disposed about the inner core, and a tinning disposed there between the highly conductive metal and the inner core. The tinning may act to diminish bimetallic conflict or corrosion that might be present between the inner core and the conductive skin.

In at least one embodiment the materials of the inner core and the metal skin are designed for exposure to an electrolyte.

In at least one embodiment, the metal skin is comprised substantially of copper.

In at least one embodiment, the ferromagnetic material comprises iron. In at least one embodiment, the ferromagnetic material is steel. In at least one embodiment, the ferromagnetic material is a stainless steel. In at least one embodiment, the ferromagnetic material is galvanized. In at least one embodiment, the insulating casing is a plastic. In at least one embodiment, the insulating casing is a polyethylene. In at least one embodiment, the transmission cable has tinning on the inner core. In at least one embodiment, the tinning is formed through hot-dipping the inner core in tin. In at least one embodiment the tinning is plated on the metal skin.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawings.

FIG. 1 is a perspective view of an inventive cable having a casing.

FIG. 2 is a cross-sectional view of an inventive cable having at least one strand extending therefrom.

FIGS. 3a-d are cross-sectional views of the core illustrating the fibers disposed within an embodied core.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For purposes of just this patent application the following terms are defined. The term “radially” refers to the position in cross-section from the center point of the cable, strand, and/or fiber. Thus if two items are “radially aligned” they are the same distance from the center point. The term “longitudinally” refers to the direction that is substantially normal to the cross-section of the cable, strand, and/or fiber at any given point. Thus if two items are “longitudinally aligned” there exists a cross-section of the cable, strand, and/or fiber that exposes both of the two items. The term “circumferentially” refers to the cross-sectional position in degrees about the center of the cable, strand, and/or fiber. Thus if two items are “circumferentially aligned” there exists a line extending from the cross-sectional center of the cable, strand, and/or fiber that passes through both of the two items.

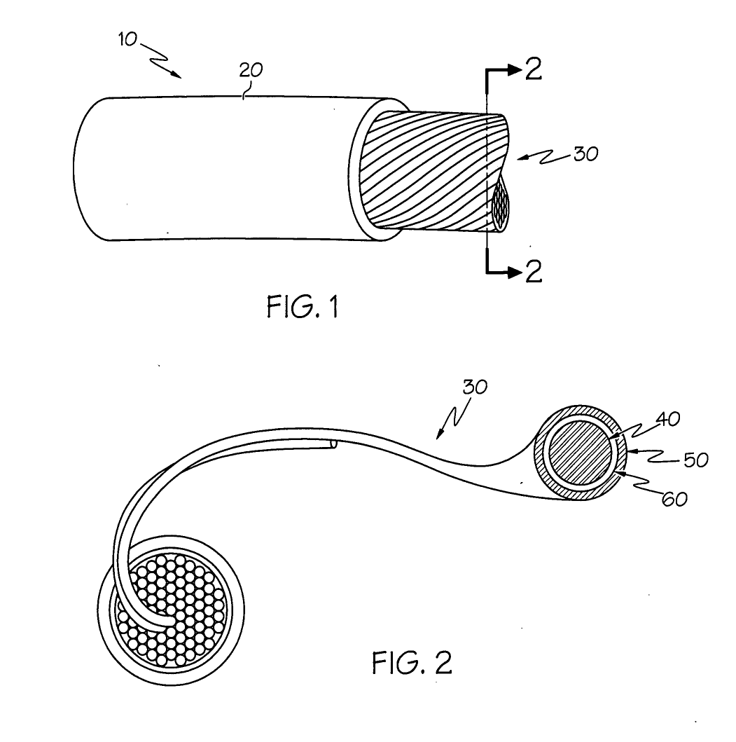

In FIG. 1 an embodied cable 10 is shown. The cable 10 includes a casing 20 disposed about a plurality of strands 30. The casing may protect the strands from external elements that could corrode the strands 30. The casing may also act to maintain the physical integrity of the plurality of strands 30. In some embodiments no casing is used. In some embodiments, the plurality of strands is replaced with a single strand. In some embodiments the strands are braided together. In some embodiments the strands are substantially parallel to one another along their length.

As shown in FIG. 2 each strand 30 includes a core portion 40 and an outer portion 50. The core portion 40 and the outer portion 50 may be separated from one another by a separating layer 60. In some embodiments the separating layer reduces bimetallic conflict, galvanic conflict, and/or galvanic corrosion. The separating layer may be a tubular member disposed about the core portion 40. In some embodiments, the separating layer 60 may be a sleeve that fits over the core portion 40. In some embodiments, the separating layer 60 may be a material plated on the outside of the core portion 40 and/or the inside of the outer portion 50. In some embodiments there is no separating layer and the outer layer 50 is disposed directly onto the core portion 40. In some embodiments, the separating layer is a semi-metal. It should also be pointed out that in some embodiments different metals than those within the text may be used in order to minimize and/or eliminate bi-metallic conflict/galvanic corrosion. Below is a table that provides some metals and their alloys indicating whether there is a risk of conflict/corrosion with various other metals. This table may be used as a reference in selecting metals for the core portion 40, the outer portion 50, and the separating layer (if desired or needed). Applicant recognizes this is not a complete listing and also recognizes the potential for errors in the chart, thus neither an error nor an omission in any way should be viewed as teaching away from any contacting metals. Similar information may be found in “Guides to good practice in Corrosion Control, Bi-metallic corrosion” prepared by Dr. R. Francis of Weir Materials and Foundries under contract of NPL (National Physical Laboratory) for the Department of Trade and Industry.

TABLE 1

| | Contact Metal | | | | | | | | | | | | | |
|---|---|---|---|---|---|---|---|---|---|---|---|---|---|---|
| | | | | | | | | | | | | | | Nickel- |
| | | | | | | | | | | | | | | Chrome_Mo |
| | | | | | | | | | | | | | | Alloys |
| | | | | | | | | | | | | | | Titanium, |
| | Mag- | | Alu- | | | | | | | | | | | silver, |
| | ne- | | min- | | | | | | | | | | | graphite |
| | sium | Zinc | ium | Cad- | | | Stain- | Lead, | | Brasses, | | Bronzes, | Nickel | Graphite, |
| | & | & | & | mi- | Steel- | Cast | less | tin and | | nickel | | cupro- | copper | gold, |
| Metal Corroding | alloys | alloys | alloys | um | carbon | iron | steels | alloys | Nickel | silvers | Copper | nickels | alloys | platinum |
| Magnesium & alloys | | X | X | X | X | X | X | X | X | X | X | X | X | X |
| Zinc & alloys | | | X | X | X | X | X | X | X | X | X | X | X | X |
| Aluminium & alloys | | | | X | X | X | X | X | X | X | X | X | X | X |
| Cadmium | | | | | X | X | X | X | X | X | X | X | X | X |
| Steel-carbon | | | | X | | X | X | X | X | X | X | X | X | X |
| Cast iron | | | | | X | | X | X | X | X | X | X | X | X |
| Stainless steels | | | | | X | X | | X | X | X | X | X | X | X |
| Lead, tin and alloys | | | | | | | X | | X | X | X | X | X | X |
| Nickel | | | | | | | | | | X | X | X | X | X |
| Brasses, nickel silvers | | | | | | X | X | X | X | | X | X | X | X |
| Copper | | | | | | | X | X | X | | | X | X | X |
| Bronzes, cupro-nickels | | | | | | | | | | | | | X | X |
| Nickel copper alloys | | | | | | | | | | | | | | X |
| Nickel-Chrome-Mo | | | | | | | | | | | | | | |
| Alloys | | | | | | | | | | | | | | |
| Titanium, silver, | | | | | | | | | | | | | | |
| graphite | | | | | | | | | | | | | | |
| Graphite, gold, | | | | | | | | | | | | | | |
| platinum | | | | | | | | | | | | | | |

X = Galvanic Corrosion Risk

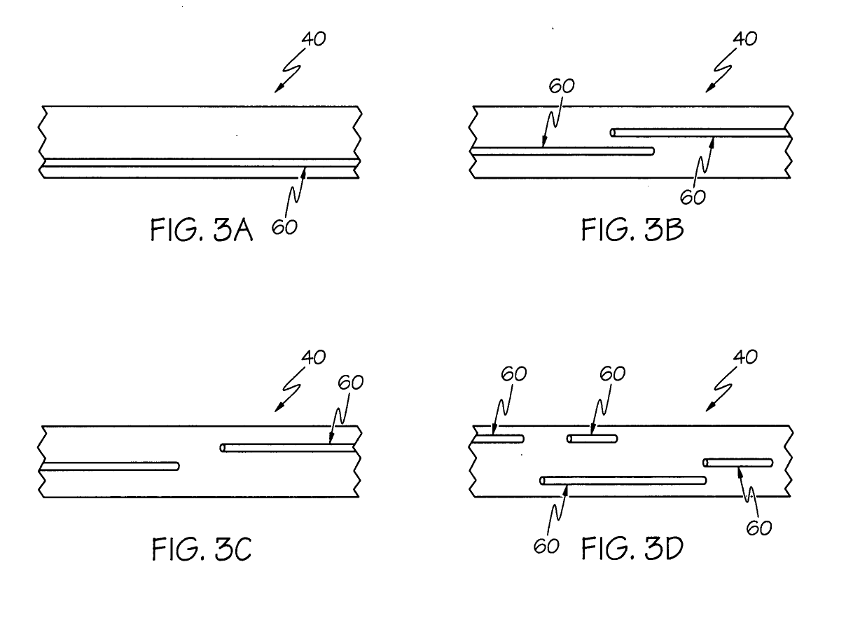

Looking again at FIG. 2, the core portion 40 may include a ferromagnetic material. In some embodiments the core portion 40 has a soft iron portion. In some embodiments, as illustrated in FIGS. 3a-3d, strands or fibers 60 may be included in the core. These strands/fibers 60 in some embodiments may be used to provide structure and/or flexibility. The strands may extend for the length of the core portion 40 as shown by the single fiber 60 of FIG. 3a. Multiple strands/fibers 60 that extend for the length of the core portion 40 may also be used. In some embodiments, multiple strands/fibers 60 extend intermittently as shown in FIG. 3c; in some embodiments the fibers 60 overlap longitudinally with other fibers 60 as shown in FIG. 3b. The fibers 60 may be of different lengths. In FIG. 3d the core 40 has fibers of different length. The fibers 60 in FIGS. 3a-d may be aligned radially or offset radially. In some embodiments some of the fibers 60 are aligned radially while some are offset radially. The multiple fibers 60 in some embodiment will include those that are radially offset with some fibers and radially offset with other fibers as well as longitudinally aligned and offset with some fibers.

In at least some of the embodiments the outer portion 50 of the embodied cable 10 carries greater than 50% of the electric current through cable 10. This may be due at least in part to the “cage effect”. The cage effect occurs when electrical energy transfers through a cable by passing through and/or around the outer portion of a wire strand. The outer portion 50 in some embodiments is up to about 25% of the radius of the cable 10. In some embodiments the outer portion is between about 25% and 50% of the radius of the cable 10. In some embodiments the outer portion 50 is between 50% and 90% of the radius of the cable 10. In some embodiments the outer portion 50 of the embodied cable 10 carries greater than 80% of the electric current through cable 10. In some embodiments the outer portion 50 of the embodied cable 10 carries less than 50% of the electric current through cable 10.

In some embodiments the magnetic field produced within and/or around the wire and core portion 40 may improve the conductivity of the wire as a whole. In some embodiments this may improve the conductivity of the core portion 40 and/or the outer portion 50. In some embodiments the magnetic field aligning the iron molecules within the core portion 40 may improve the conductivity of the core portion 40 and/or outer portion 50.

In some embodiments, an energy system includes at least one of the embodied cables attached to at least one transformer.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A transmission cable comprising at least one conductive strand surrounded by an insulating casing, the at least one conductive strand including an inner core of a ferromagnetic material, a highly conductive metal skin disposed about the inner core, and a separating layer disposed there between the highly conductive metal and the inner core.

2. The transmission cable of claim 1 wherein the metal skin is comprised substantially of copper.

3. The transmission cable of claim 1 wherein the ferromagnetic material comprises iron.

4. The transmission cable of claim 1 wherein the ferromagnetic material is steel.

5. The transmission cable of claim 4 wherein the ferromagnetic material is a stainless steel.

6. The transmission cable of claim 4 wherein the ferromagnetic material is galvanized.

7. The transmission cable of claim 1 wherein the insulating casing is a plastic.

8. The transmission cable of claim 7 wherein the insulating casing is a polyethylene.

9. The transmission cable of claim 1 wherein the separating layer comprises tin.

10. The transmission cable of claim 9 wherein the separating layer is formed through hot-dipping the inner core in tin.

11. The transmission cable of claim 9 wherein the separating layer is plated on the inner surface of the metal skin.

12. The transmission cable of claim 9 wherein the separating layer is plated on the inner core.

13. A transmission cable comprising at least one conductive strand having an inner core of a ferromagnetic material and a highly conductive metal skin disposed about the inner core.

14. The transmission cable of claim 13 wherein the at least one conductive strand is surrounded by an insulating casing.

15. The transmission cable of claim 14 having a separating layer disposed between the inner core and the metal skin.

16. The transmission cable of claim 14 wherein the separating layer is comprised of tin.

17. The transmission cable of claim 14 wherein the insulating casing is comprised of metal capable of reducing electromagnetic frequencies from entering the conductive strand.

18. An electricity transmission system comprising an electrical source, the electrical source creating electricity, a transmission cable in electrical communication with the electrical source such that electricity is transferred through the cable, the cable comprising at least one conductive strand having an inner core of a ferromagnetic material and a highly conductive metal skin disposed about the inner core.

19. The electricity transmission system of claim 18 wherein the at least one conductive strand is surrounded by an insulating casing.

20. The electricity transmission system of claim 19 having a separating layer disposed between the inner core and the metal skin, the separating layer comprising tin.
